(19) United States
(12) Patent Application Publication
(10) Pub. No.: US 2015/0032751 A1
(43) Pub. Date: Jan. 29, 2015

(54) Methods and Systems for Utilizing Subject Matter Experts in an Online Community

(71) Applicant: LITHIUM TECHNOLOGIES, INC., Emeryville, CA (US)

(72) Inventors: Edison Ting, Dublin, CA (US); Kirk Yokomizo, Oakland, CA (US); Hao Tang, Union City, CA (US); Johny Vinh Tuan Lam, Berkeley, CA (US); Jack Herrington, Union City, CA (US); Ed VanSiclen, Alamo, CA (US)

(21) Appl. No.: 13/950,268

(22) Filed: Jul. 24, 2013

(51) Int. Cl. G06F 17/30

(52) U.S. Cl. CPC G06F 17/30598
USPC 707/738

(57) ABSTRACT

A disclosed method recommends a social contact in an online community for a business entity. The method is performed by one or more servers. A first posting is received at a website for the online community. The first posting is from a first user and poses a first question. The first posting is categorized as pertaining to a first subject matter area. A second posting is received at the website. The second posting is from a subject matter expert for the first subject matter area and is responsive to the first question. A third posting is identified that was previously received at the website from a second user. The third posting is categorized in the first subject matter area and has a responsive fourth posting provided by the subject matter expert. The method recommends that the first user contact the second user regarding the first subject matter area.

### TECHNICAL FIELD

The disclosed implementations relate generally to online social communities, and more specifically to identifying and utilizing subject matter expertise within an online social community.

### BACKGROUND

Online social communities can help people resolve problems or issues. For example, an online community for a business entity can enable users to find answers to their problems, thus reducing the reliance on technical support. Forums contain “problem-solution” type interactions, where people have issues and ask for advice from others. Other people within the community may provide solutions or suggestions. One drawback to a forum is that a user does not get an immediate answer, and may need to wait indefinitely until some other user chooses to post a response. Another drawback is that there is no guarantee of quality for the response. Any user, whether knowledgeable or not, can post a response.

Some online communities improve on this model by making the forums searchable or consolidating postings into a searchable knowledge base. A significant drawback of this approach is that a user looking for a specific answer to a specific question may need to wade through many postings in order to find the ones most relevant. In addition, different users may use different words to identify the same issue, so a keyword search may not even find the most relevant postings. Furthermore, even with a knowledge base, there are still many postings by people with limited knowledge or expertise.

### SUMMARY

Disclosed implementations address these and other problems using several techniques, including natural language processing. Natural language processing (sometimes referred to as “text analytics” herein) can extract issue statements as well as matching solutions entered by members of a forum. The processing constructs structured data elements and establishes relationships between those data elements, and correlates the data with other related information such as authors and view counts. By pairing extracted issues with the authors of postings over time, information about what problems an author solves can be used to identify experts on specific topics within the community.

Furthermore, having identified subject matter experts for certain topic areas, that information can be used to provide more rapid responses to issues posed in new postings. A new posting can be directed to an expert for the right subject matter area, the new posting can be linked to specific issue/answer pairs where the answers were provided by the experts, the new posting can be linked to specific recommendations by the experts for products or actions, or the user can be directed to contact other users who have had problems solved by the same subject matter expert.

In some implementations, information from the online community can be supplemented with data extracted from other public online social media. However, unlike an online community for a specific business entity, typical social media cover a vast array of topics. In order to get relevant information, it is necessary to filter or mine the data.

In accordance with some implementations, a method identifies a subject matter expert in an online community for a business entity. The method is performed at a server having one or more processors and memory. The method identifies a plurality of subject matter areas for postings on a website for an online community, and each posting is assigned to one or more of the subject matter areas. For a first subject matter area, a set of users is identified, each of whom has authored a plurality of postings assigned to the first subject matter area. A first user of the set of users is identified as a subject matter expert for the first subject matter area based on a determination that the first user's postings assigned to the first subject matter area have consistently been highly relevant to the first subject matter area over a predefined period of time.

In accordance with some implementations, the determination that a posting is highly relevant to the first subject matter area uses a relevance metric based on syntactic patterns. In some implementations, the determination that a posting is highly relevant to the first subject matter area uses a relevance metric based on semantic analysis. Some implementations use both syntactic patterns and semantic analysis. In some implementations, the determination is based on correlating postings of one user with postings of another user that have already been determined to be highly relevant to the subject matter area. In some implementations, correlating the postings of one user with previous postings of another user is combined with syntactic or semantic analysis.

In some implementations, the determination that the first user's postings assigned to the first subject matter area have consistently been highly relevant to the first subject matter area over a predefined period of time comprises designation of one or more of the first user's postings assigned to the first subject matter area as an accepted solution or receiving sufficient positive feedback from other users of the online community. In some implementations, the determination is based in part on an affinity metric between users and subject matter areas.

In accordance with some implementations, the designation of the first user as a subject matter expert for the first subject matter area is utilized in various ways to assist users with new postings to the online community. In some implementations, a new posting is received from a second user, and the new posting is assigned to one or more subject matter areas, including the first subject matter area. Based on the designation of the first user as a subject matter expert for the first subject matter area, the second user is directed to the first user.

In accordance with some implementations, the online community maintains a database of issue/answer pairs based on information extracted from existing postings. For each issue/answer pair, the answer is extracted from a posting by a subject matter expert for a subject matter area pertaining to the issue. When a new posting is received from a second user and the new posting has an issue that corresponds to an issue posed in one or more of the issue/answer pairs, those issue/answer pairs are presented to the second user.

In accordance with some implementations, the online community maintains a list of products and recommendations for those products. The recommendations are aggregated based on postings of experts for certain subject matter areas. In some implementations, the aggregated recommendations include both positive recommendations and negative recommendations (sometimes referred to as detractions). Note that a detraction is not inherently disparagement of a product per se, and may simply identify circumstances where a certain product is not useful, effective, or valuable. For example, certain high-performance automobile tires may not be useful for a car that is not capable of high performance or for use during certain seasons due to weather. When a new posting is entered by a second user and assigned to a subject matter area, some implementations correlate that subject matter area with recommended products, and provide those product recommendations to the second user.

In accordance with some implementations, a method recommends a social contact in an online community for issues relating to a business entity. The method is performed at a server having one or more processors and memory. A first posting is received at a website for the online community. The first posting is from a first user and the first posting poses a first question. The first posting is categorized as pertaining to a first subject matter area relevant to the business entity. A second posting is received at the website. The second posting is from a subject matter expert in the first subject matter area and the second posting is responsive to the first question. The method identifies a third posting previously received at the website from a second user. The third posting is categorized in the first subject matter area and has a responsive fourth posting provided by the subject matter expert. Accordingly, the method recommends that the first user contact the second user regarding the first subject matter area.

In some instances, the first user contacts the second user regarding the first subject matter area, and the second user responds by providing information corresponding to the first subject matter area. In some instances, the information corresponding to the first subject matter area provides detail about the subject matter area not available in the postings by the subject matter expert. In some instances, the information corresponding to the first subject matter area includes a recommendation for a specific product or service provided by the business entity.

### BRIEF DESCRIPTION OF THE DRAWINGS

FIG. 1 illustrates the context in which some implementations of the present invention operate.

FIG. 2 is a block diagram illustrating a user computing device in accordance with some implementations.

FIG. 3 illustrates a website server for an online social community in accordance with some implementations.

FIG. 4 illustrates a posting by a user to an online social community in accordance with some implementations.

FIG. 5 illustrates a process of rapidly providing useful information to a user of an online social community in accordance with some implementations.

FIG. 6 illustrates a process of constructing aggregated recommendations from subject matter experts, and providing those recommendations to a user in accordance with some implementations.

FIG. 7 illustrates a method of establishing a communication channel between two users in an online social community in accordance with some implementations.

FIG. 8 illustrates natural language processing of postings to an online social community in accordance with some implementations.

FIG. 9 illustrates aspects of postings to an online social community in accordance with some implementations.

FIGS. 10A-10D provide a flowchart for identifying subject matter expertise in an online social community in accordance with some implementations.

FIGS. 11A-11B provide a flowchart for utilizing subject matter experts to recommend connections between members of an online social community in accordance with some implementations.

Like reference numerals refer to corresponding parts throughout the drawings.

### DESCRIPTION OF IMPLEMENTATIONS

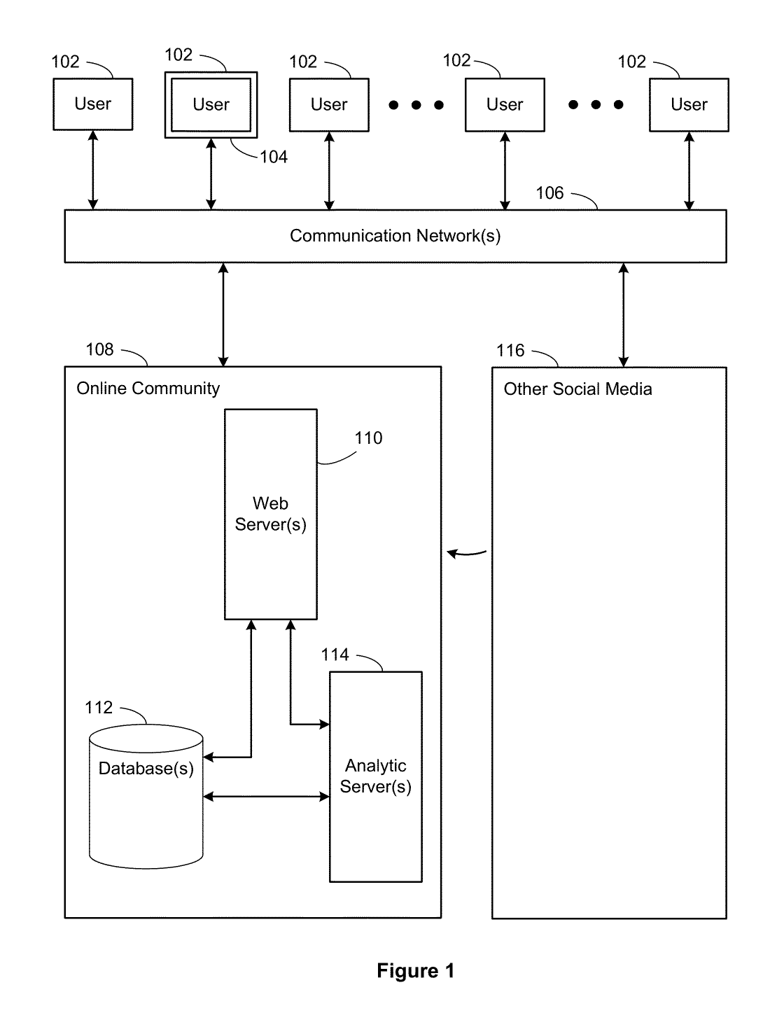

FIG. 1 illustrates the context in which implementations of the present invention operate. An online community 108 includes one or more web servers 110 that provide web pages for a user interface for the community 108. The data for the online community 108 is stored in one or more databases 112, including community postings 402, products or services 336 offered by the business entity to which the online community 108 belongs, recommendations 350 (e.g., for products), and so on. In addition, the online community 108 includes one or more analytic servers 114, which extract information from postings 402, identify users who are subject matter experts in certain areas, identify solutions to users' issues, aggregate postings to identify recommendations, integrate data from other social media 116 (e.g., Twitter or Facebook), and so on.

Users 102 access the online community 108 over communication network(s) 106, such as local area networks, wide area networks, the Internet, and so on. Users use one or more computing devices 200 to connect to the network 106. Computing devices include desktop computers, laptop computers, tablet computers, smart phones, or any other electronic device with a web browser or other appropriate application software and connectivity to the network 106.

As shown in FIG. 1, some users 102 are designated as subject matter experts 104 for specific subject matter areas. As described in more detail below, a subject matter expert 104 can be identified in various ways. That expertise can be used in various ways to resolve issues posed by other users 102.

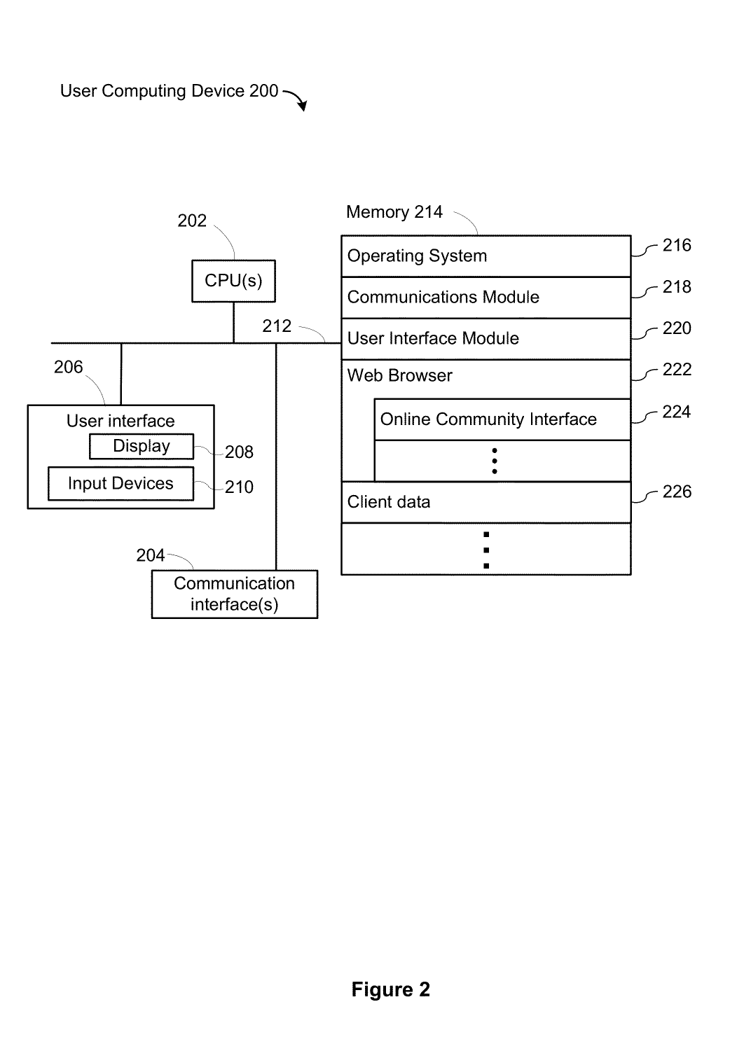

FIG. 2 is a block diagram illustrating a user computing device 200, according to some implementations. The user computing device 200 can be a desktop computer, laptop computer, a tablet computer, a smart phone, or any other electronic device that can connect to other computing devices over a communication network 106. The user device 200 typically includes one or more processing units (CPUs) 202, one or more network or other communications interfaces 204, memory 214, and one or more communication buses 212 for interconnecting these components. The communication buses 212 may include circuitry (sometimes called a chipset) that interconnects and controls communications between system components. The user computing device 200 also includes a user interface 206 comprising a display device 208 and input devices 210 (e.g., keyboard, mouse, touch screen, keypads, etc.). The memory 214 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. The memory 214 may optionally include one or more storage devices remotely located from the CPU(s) 202. The memory 214, or alternately the non-volatile memory device(s) within the memory 214, comprises a computer readable storage medium. In some implementations, the memory 214 stores the following programs, modules and data structures, or a subset thereof:
an operating system 216 that includes procedures for handling various basic system services and for performing hardware dependent tasks;
a communication module 218 that is used for connecting the user computing device 200 to other computer systems via the one or more communication interfaces 204 (wired or wireless) and one or more communication networks 106, such as the Internet, other wide area networks, local area networks, metropolitan area networks, and so on;
a user interface module 220 that receives commands from the user via the input devices 210 and generates user interface objects in the display device 208;
a web browser or other appropriate application software 222 that enables a user to access resources, web pages, remote applications, and/or data sources over a communication network;
an online community interface 224, providing access to the online community 108. In some implementations, online community interface 224 executes within the web browser 222; other implementations provide a community software application that executes on (or partially on) the user device 200 outside of the web browser 222 and/or as an application embedded therein; and
client data 226, such as cookies or other data saved locally and used by the online community interface 224.

Each of the above identified elements may be stored in one or more of the previously mentioned memory devices, and corresponds to a set of instructions for performing a function described above. The set of instructions can be executed by one or more processors (e.g., the CPUs 202). The above identified modules or programs (i.e., sets of instructions) need not be implemented as separate software programs, procedures, or modules, and thus various subsets of these modules may be combined or otherwise re-arranged in various implementations. In some implementations, the memory 214 may store a subset of the modules and data structures identified above. Furthermore, the memory 214 may store additional modules and data structures not described above.

Although FIG. 2 shows a user computing device 200, FIG. 2 is intended more as a functional description of the various features that may be present in a user device than as a structural schematic of the implementations described herein. In practice, and as recognized by those of ordinary skill in the art, items shown separately could be combined and some items could be separated.

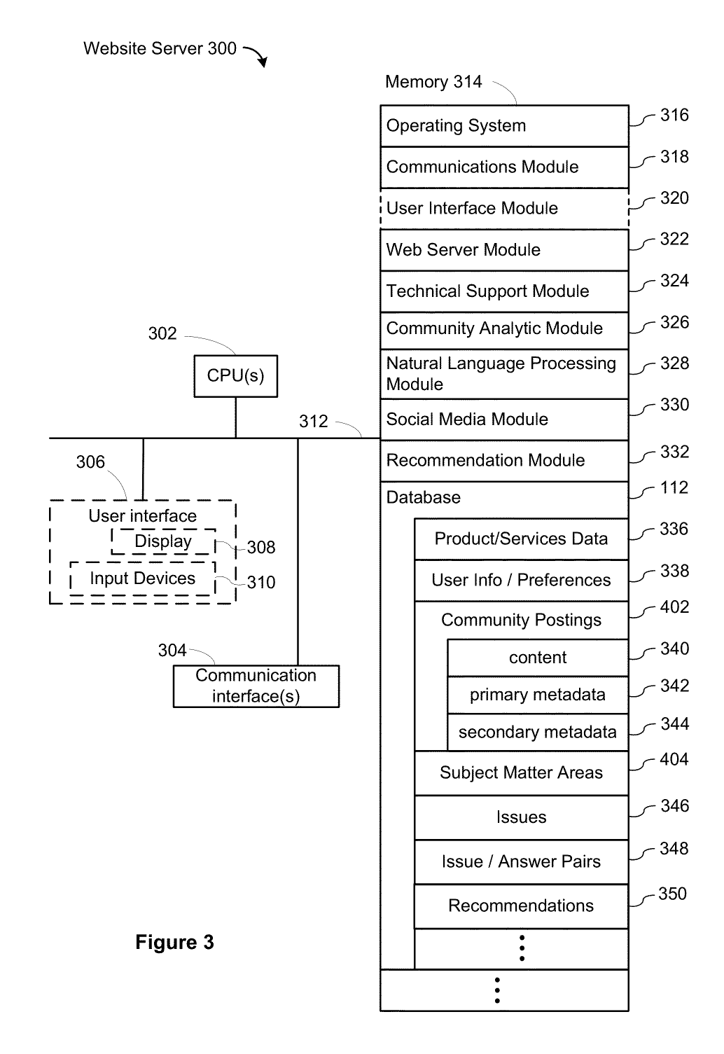

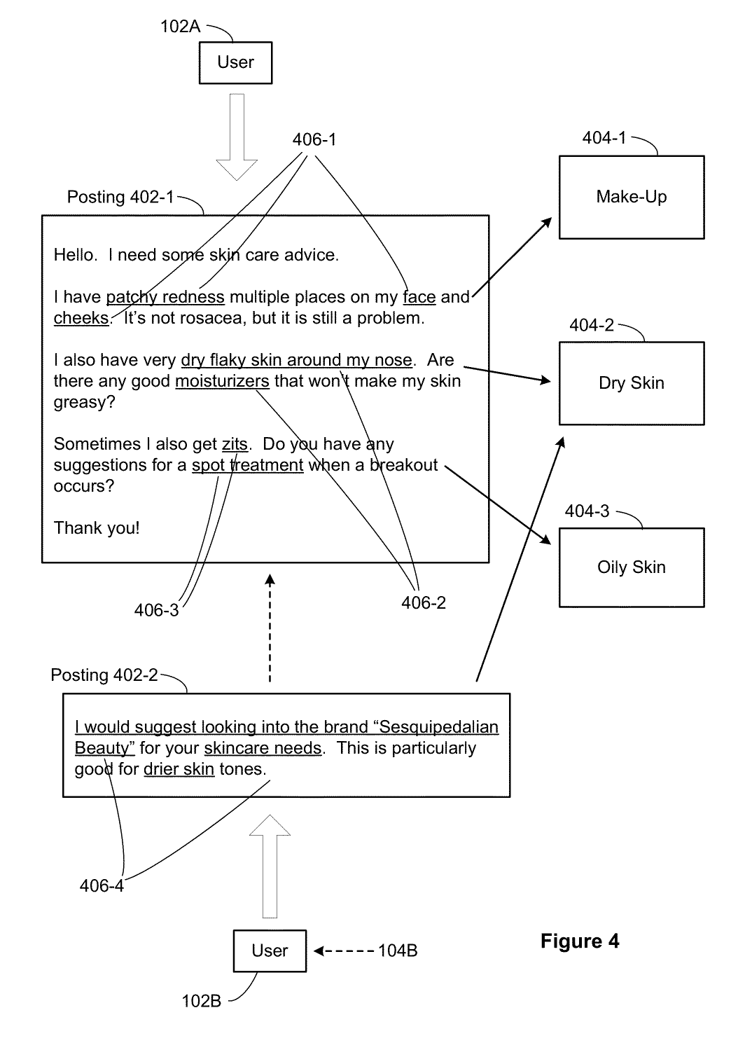

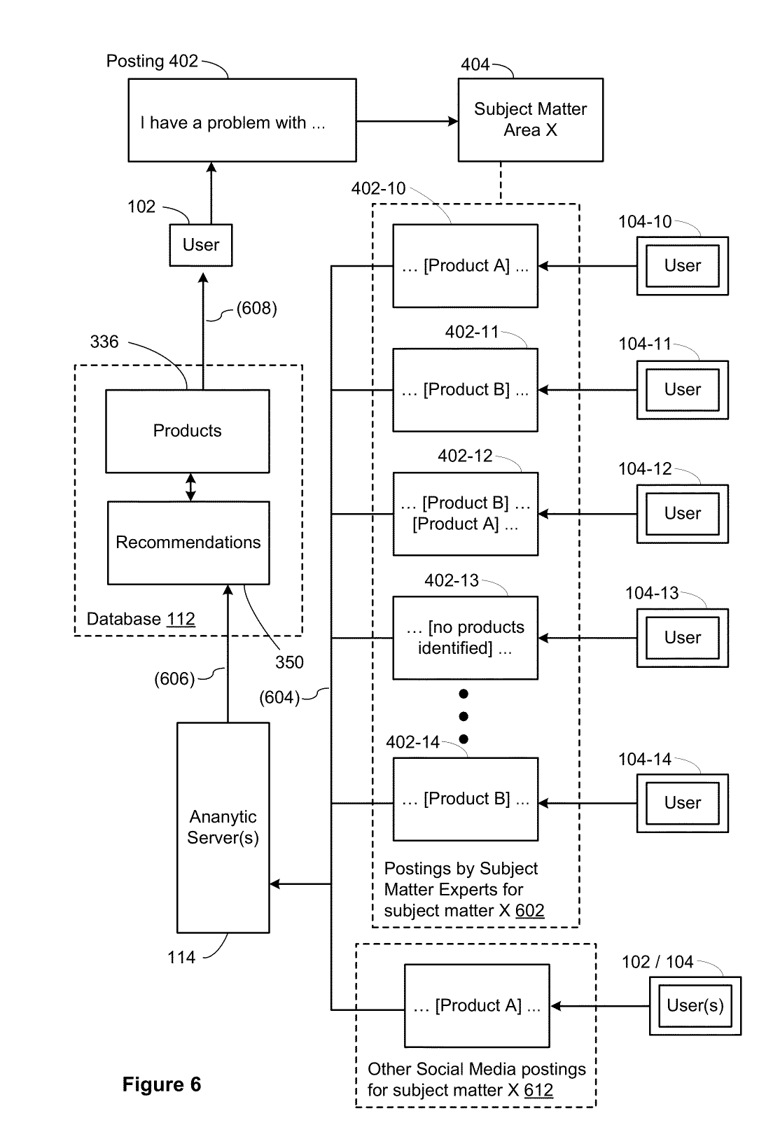

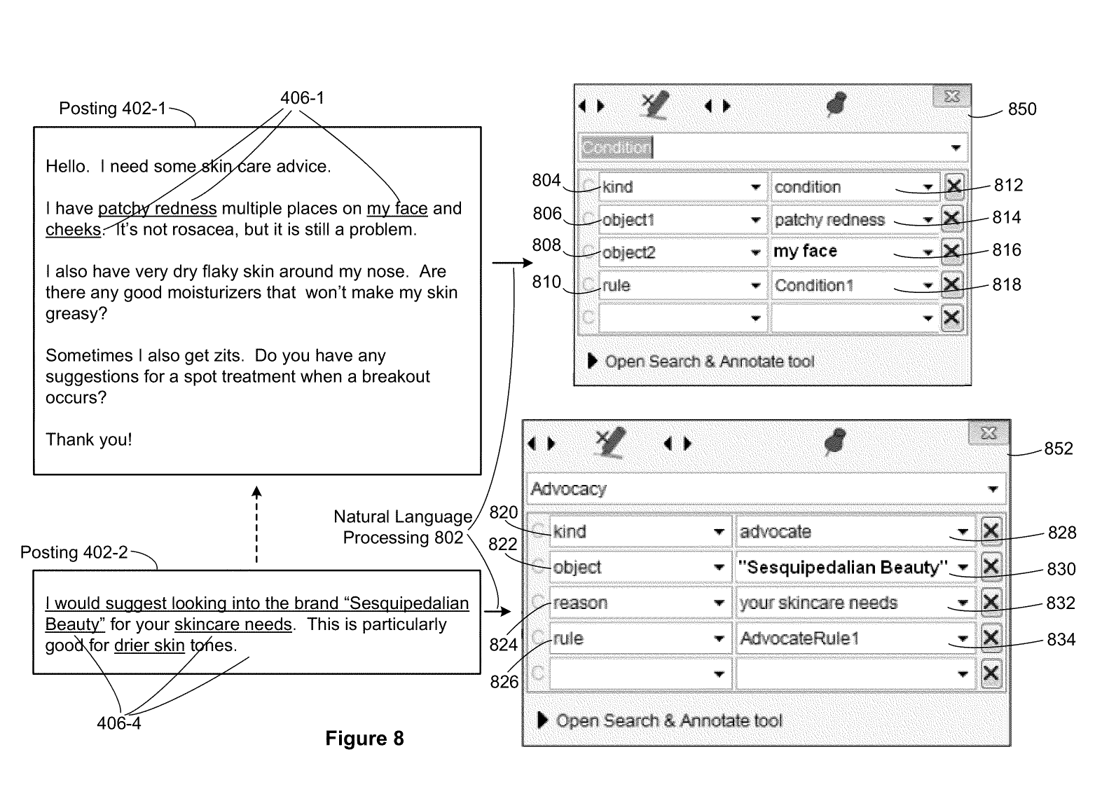

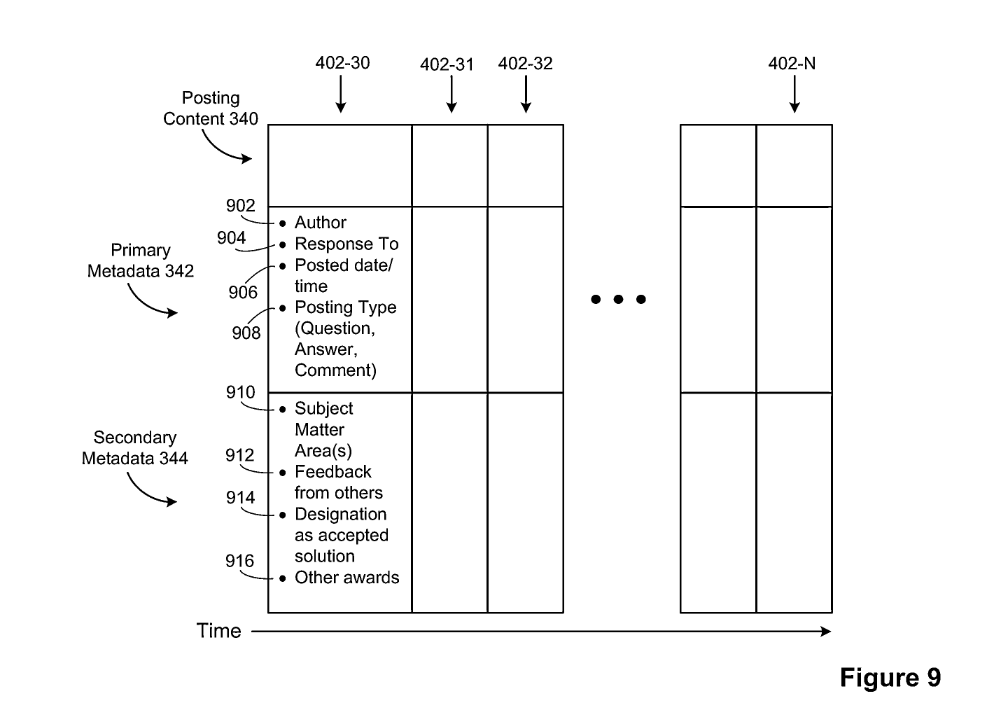

FIG. 3 is a block diagram illustrating a website server 300, according to some implementations. A website server 300 typically includes one or more processing units (CPUs) 302, one or more network or other communications interfaces 304, memory 314, and one or more communication buses 312 for interconnecting these components. The communication buses 312 may include circuitry (sometimes called a chipset) that interconnects and controls communications between system components. The website server 300 optionally includes a user interface 306 comprising a display device 308 and input devices 310 (e.g., keyboard, mouse, touch screen, keypads, etc.). The memory 314 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. The memory 314 optionally includes one or more storage devices remotely located from the CPU(s) 302. The memory 314, or alternately the non-volatile memory device(s) within the memory 314, comprises a computer readable storage medium. In some implementations, the memory 314 stores the following programs, modules, and data structures, or a subset thereof:
an operating system 316, which includes procedures for handling various basic system services and for performing hardware dependent tasks;
a communication module 318, which is used for connecting the website server 300 to other computers via the one or more communication interfaces 304 (wired or wireless) and one or more communication networks 106, such as the Internet, other wide area networks, local area networks, metropolitan area networks, and so on;
an optional user interface module 320, which receives commands from the user via the input devices 310 and generates user interface objects in the display device 308;
a web server module 322, which receives resource requests (e.g., HTTP requests) and returns web pages or other resources to the requestor. The web server module may run Apache Tomcat, Microsoft® Internet Information Server, or other similar software;
an online technical support module 324, which provides a user interface for users to ask questions and respond to those questions. In some implementations, the technical support module 324 is automated, but in other implementations, the technical support module includes support personnel, who may communicate with users through online chat, email, etc. to answer questions;
a community analytic module 326, which analyzes and processes community postings 402 and other data. In some implementations, the community analytic module computes various metrics to quantify users' interactions with the online community 108 and to provide various feedback to encourage greater participation by users 102. In some implementations, the community analytic module 326 includes a first level feedback module, which computes metrics that quantify a user's direct involvement with the community. For example, the metrics may include number of postings, number of postings on distinct topics, number of questions asked, number of responses to other users' questions, and so on. The first level metrics are displayed for each user in the user interface so that each user has quantified feedback. In some implementations, the feedback for the first level metrics includes a ranking or comparison with other users. Generally, such feedback is provided for a relevant subset of the users. For example, a comparison of website activity for new users (a.k.a. “newbies”). (It would not be particularly useful or helpful to compare the activity of newbies to the activity of users who have been contributing to the community for a long time.) In some implementations, the community analytic module 326 also includes a second level feedback module, which includes a set of second level metrics that quantify a user's interactions with the community based on the evaluations of other users. For example, the second level metrics identify the number of postings by each user that have received kudos from others, the number of postings that have been designated as accepted solutions, the number of postings that have been nominated for incorporation in a knowledge base (sometimes called a “tribal knowledge base” or “TKB”), the number of knowledge base articles written by each user, and so on. The analytic module 326 provides feedback to each user about the second level metrics in the user interface for the online community 108. In some implementations, the community analytic module 326 also includes a third level feedback module, which defines certain awards based on various combinations of the first and second level metrics. For example, an award may be defined that includes all users 102 who have been received 50 kudos for their postings, had 20 responses nominated for knowledge base articles, and have been active in the community for at least a year. Implementations generally support award definitions that are configurable and enable multiple such awards, each with its own definition. In general, multiple people can receive a specified award, as long as each user meets the criteria. Some awards specifically include a limit on the recipients, such as the first person this year to meet certain criteria, or the first N people to meet the criteria, where N is a positive integer. The awards are sometimes referred to as badges or meta-badges depending on the criteria required to receive the award. The Community analytic module 326 displays the awards in the user interface, either privately (only the user sees her own awards), publicly (everyone can see the awards), or semi-privately (only a relevant limited set of people sees each award). In addition, the analytic module 326 extracts information from postings 402, identifies users who are subject matter experts in certain areas, identifies solutions to users' issues, aggregates postings to identify recommendations, integrates data from other social media 116 (e.g., Twitter or Facebook), and so on;
a natural language processing module 328 that analyzes text from community postings 402 or other social media 116 to identify issues 346, products 336, solutions, etc. that are relevant to the online community 108. The natural language processing module is described below with respect to FIG. 8;
some implementations include a separate social media module 330 that extracts relevant information from other social media 116, and integrates that information into recommendations and problem resolutions. In some implementations, this functionality is implemented by the community analytic module 326;
some implementations include a separate recommendation module 332 that extracts data from postings 402 to the community 108 as well as from external social media 116 to form recommendations 350 (e.g., for products 336), and provides the recommendations to users 102. The recommendation module 332 is described below with respect to FIG. 6. Some implementations include the recommendation functionality in the community analytic module 326;
one or more databases 112, which store data for the website 108. The database 112 may include relational database(s), non-relational database(s), file server(s), and/or other storage means such as cloud storage;
the database 112 stores product and services data 336 for the business entity. This includes descriptions of products, pricing, availability, store locations, and so on;
the database 112 stores user information 338 for each user 102, including a user ID (e.g., an email address) and password (or other authentication information), certain profile information (which may be optional), and a set of user preferences. The user preferences 338 may specify user interface features, what topics are of interest to the user, what notifications are allowed (e.g., notifications of upcoming events), and so on. The user information 336 may identify a user 102 as a subject matter expert 104 for specific subject matter areas 404;
the database 112 stores community postings 402, which may comprise forums or discussion boards, including comments, questions, and answers provided by users 102. Each posting includes the actual content 340 of the posting and additional metadata 342 and 344. Some implementations subdivide the metadata into primary metadata 342 (e.g., the author of each posting, the time of the posting, what posting it is responding to) and secondary metadata 344 (e.g., subject matter areas associated with the posting (supplied by the user or inferred from the posting by natural language processing or subsequent human categorization), links to subsequent responses, whether the posting receives recognition from others, and so on). Postings 402 are described below with respect to FIGS. 4-9 and posting metadata 342 and 344 is described below with respect to FIG. 9;
the database 112 stores a list of subject matter areas 404, and links the subject matter areas 404 to users 102 who have been identified as subject matter experts 104 for those areas 404;
the database 112 stores a list of issues 346 that have been presented by one or more users 102, as well as data about those issues 346 (e.g., number of postings that have identified that issue). The issues 346 are typically extracted from postings 402 by the natural language processing module 328. This is described below with respect to FIGS. 4, 5, and 8. In some cases, a single posting can includes multiple issues (or no issues at all);
the database 112 also stores a set of issue/answer pairs 348, which can be used to provide users with answers to their posted issues 346. Rather that forcing the user to search though mounds of postings, the natural language processing module 328 analyzes a new posting 402, identifies the issues 346 in the posting 402, correlates the issues 346 in the new posting 402 with known issues 346, and provides the corresponding issue/answer pairs 348. In some implementations, the answers in the issue/answer pairs 348 can include recommendations 350 for products or services 336 provided by the business entity that manages the online community 108; and
the database 112 stores recommendations 350, which include both recommendations for products or services 336, as well as recommended actions. A process of forming recommendations is illustrated in FIG. 6.

Each of the above identified elements may be stored in one or more of the previously mentioned memory devices, and corresponds to a set of instructions for performing a function described above. The set of instructions can be executed by one or more processors (e.g., the CPUs 302). The above identified modules or programs (i.e., sets of instructions) need not be implemented as separate software programs, procedures, or modules, and thus various subsets of these modules may be combined or otherwise re-arranged in various implementations. In some implementations, the memory 314 stores a subset of the modules and data structures identified above. Furthermore, the memory 314 may store additional modules and data structures not described above.

Although FIG. 3 shows a website server 300, FIG. 3 is intended more as a functional description of the various features that may be present in a set of servers than as a structural schematic of the implementations described herein. In practice, and as recognized by those of ordinary skill in the art, items shown separately could be combined and some items could be separated. In fact, FIG. 1 illustrates an implementation with at least three website servers 300 (one or more website servers 300 for the web servers 110, one or more website servers 300 for the analytic servers 114, and one or more website servers for the database 112). The actual number of website servers 300 used and how features are allocated among them will vary from one implementation to another, and may depend in part on the amount of data traffic that the system must handle during peak usage periods as well as during average usage periods.

Each of the methods described herein may be implemented by instructions that are stored in a computer readable storage medium and that are executed by or on one or more processors of the website servers 300 or user computing devices 200. Each of the functional operations shown in FIGS. 2 and 3, or in the figures below may correspond to instructions stored in a computer memory or computer readable storage medium.

FIG. 4 illustrates a posting 402-1 at an online community 108 for a business entity that offers skincare products. A user 102A enters the posting 402-1 using the online community interface 224 displayed on the user's computing device 200. The natural language processing module 328 analyzes the posting 402-1 to identify issues 346 and corresponding subject matter areas 404. Certain keywords 406 are identified, and from those keywords, portions of a posting are identified as an issue 346 and assigned to a subject matter area 404.

As illustrated in FIG. 4, the sentences “Hello,” “I need some skin care advice,” and “Thank you” do not have any keywords 406, and do not represent any issues. In this illustration, the user 102 has neatly specified three distinct issues 346 in three separate paragraphs of the posting 402-1. Although well-structured postings 402 make it easier for the natural language processing module 328 to identify the issues 346, users 102 are not required to be so organized.

The natural language processing module 328 identifies the keywords 406-1 in the first paragraph (“patchy redness,” “face,” and “cheeks”) and assigns this to the “Make-Up” subject matter area 404-1. In some implementations a list of keywords and key phrases is maintained in the database 112. Note that different implementations utilize different subject matter areas 404. For example, a skincare company that offers lots of make-up options may have more specific subject matter areas (e.g., a subject matter area for skin redness). Also note that “rosacea” is not included in the keywords 406-1 in this example. Although “rosacea” would typically be identified as a keyword, the natural language processing module 328 has noticed the “not” before “rosacea,” and thus correctly determined that the user 102 is not seeking a solution for rosacea.

The natural language processing module 328 finds keywords 406-2 in the second paragraph, and assigns this portion of the posting 402-1 to the “Dry Skin” subject matter area 404-2. Some implementations find the keywords and key phrases by matching a list of terms and phrases stored on the database 112. For example, “dry skin” may be saved in the database as a key phrase. In some implementations, the structure of each sentence is used to identify the key words. For example, both “dry” and “skin” may be identified as important words; when they appear together in close proximity (e.g., “dry skin” or “skin is dry”), they form a key phrase. The natural language processing module 328 identifies keywords 406-3, and assigns this portion of the posting 402-1 to subject matter area “Oily Skin” 404-3. Note that neither the word “oily” nor the word “skin” appears in this portion of the posting, but the term “zits” is known to be associated with oily skin. In particular, the natural language processing module does not require specific keywords. Indeed, in some implementations, the natural language processing module 328 learns new words or phrases based on the postings (e.g., using a neural network or by human review), and adds them to the list of keywords in the database 112. In some implementations, human review is used to verify or correct a sampling of the work done by the natural language processing module 328, and thus over time the assignment to subject matter areas generally becomes more accurate.

FIG. 4 also illustrates that a second user 102B has provided a posting 402-2 in response to the original posting 402-1. Just like the original posting 402-1, the natural language processing module 328 scans the posting 402-2 to identify keywords 406-4. Based on these keywords, the reply posting 402-2 is assigned to the subject matter area “Dry Skin” 404-2. It is possible that the reply posting 402-2 could be relevant to the other two subject matter areas 404-1 and 404-3 as well, but it is not as certain. Because the reply posting 402-2 includes the phrase “drier skin” 406-4, there is reasonable confidence that the reply does apply to the “Dry Skin” subject matter area, but there is much less confidence that the reply posting 402-2 applies to the other two subject matter areas 404-1 and 404-3. In some implementations, a posting 402 is assigned to a subject matter area 404 when the confidence exceeds a threshold level (e.g., confidence >60%, or confidence >90%). The second user 102B may already be designated as a subject matter expert 104B for the “Dry Skin” subject matter areas 404-2, or that designation may come later. In fact, providing the reply posting 402-2 may be one of the reasons that user 102B is later designated as a subject matter expert 104B.

In general, designation as a subject matter expert requires more than a single useful posting. For example, even assuming reply posting 402-2 is extremely useful, if the user 102B has no other useful postings for this subject matter area 404-2, the user 102B is generally not considered a subject matter expert. Some criteria that are used in designating a person as a subject matter expert include consistent relevant solutions over a period of time, recognition of a posted solution as an accepted solution, consistent positive recognition by others in the online community 108, and so on. This is described below with respect to FIG. 9.

FIG. 4 also illustrates that being a “subject matter expert” 104 is tied to specific subject matter areas. For example, being a subject matter expert for “Dry Skin” 404-2 does not inherently make the same person a subject matter expert for “Make-Up” 404-1 or “Oily Skin” 404-3.

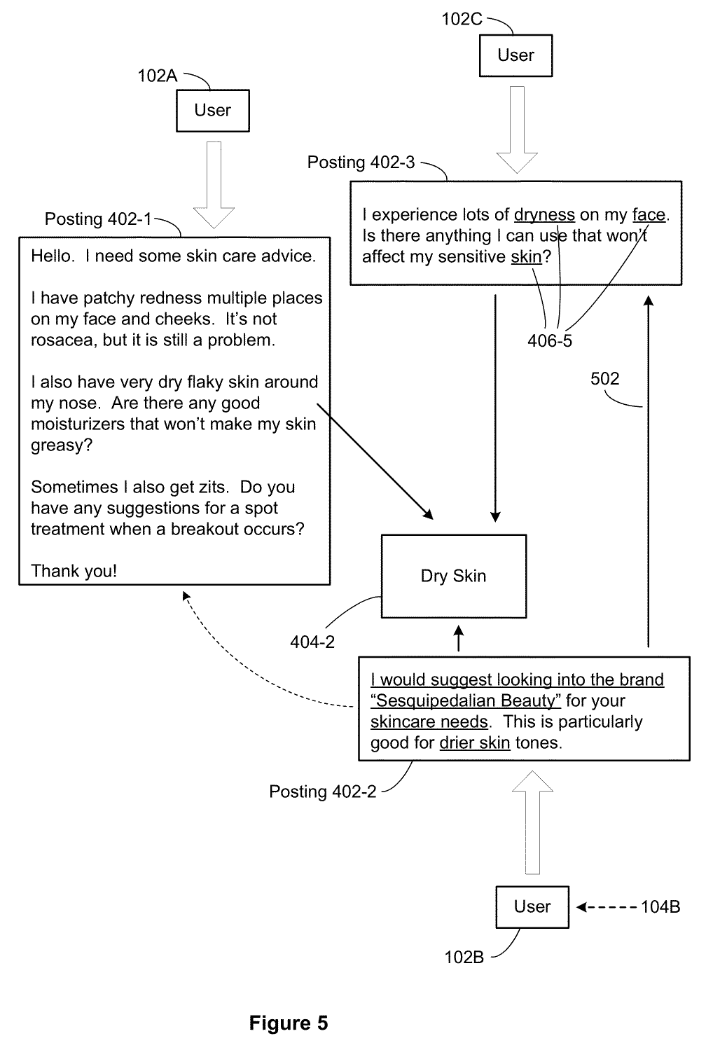

Some implementations store issues 346 and issue/answer pairs 348. From the postings 402-1 and 402-2 in FIG. 4, the analytic module 326 may store the issue “I have dry flaky skin around my nose. Are there any good moisturizers that won't make my skin greasy?” 346, and combine this with the content 340 of the posting 402-2 to make an issue/answer pair 348. This is illustrated further in FIG. 5.

FIG. 5 illustrates the same postings 402-1 and 402-2 that are illustrated in FIG. 4. As noted above, the portion “I also have very dry flaky skin around my nose. Are there any good moisturizers that won't make my skin greasy?” of posting 402-1 is assigned to the subject matter area “Dry Skin” 404-2, and the reply 402-2 is assigned to the same subject matter area 404-2. A third user 102C enters a new posting 402-3 at the online community 108, which is analyzed by the natural language processing module 328 to identify a set of keywords 406-5. Based on the keywords 406-5, the posting 402-3 is assigned to the “Dry Skin” subject matter area 404-2. In some implementations, the recommendation module 332 recommends (502) the solution in posting 402-2 based on the subject matter area 404-2. In other implementations, the recommendation module 332 scans the set of issue/answer pairs 348 for issues 346 that are assigned to the subject matter area 404-2 and correlate to the issue presented in the new posting 402-3. In this example, the new posting has an issue with dryness of skin on the face, which correlates highly to the second issue presented in the first posting 402-1, and thus the reply 402-2 is provided (502) to the first user. In this scenario, the recommendation module 332 is able to provide the response quickly because there is already a solution to the user's problem saved in the database 112.

As just described, the recommendation module can provide (502) solutions either based on the subject matter area 404-2 alone, or based on a more detailed analysis of the specific issue. Some implementations use both methods, and use an appropriate method based on the number of solutions already stored. For example, if there are very few solutions assigned to a certain subject matter area 404, then it may be useful to a user to see all of those solutions. On the other hand, if a certain subject matter area has hundreds or thousands of solutions, then a more detailed analysis of the specific user issue may provide a more useful solution.

Administrators of disclosed implementations can determine the level of detail assigned to a subject matter area 404. The subject matter areas can be narrow or broad depending on the various factors, such as the number and variety of products offered by the business entity. In some implementations, the subject matter areas are very narrow, in which case a subject matter area 404 is essentially a single issue.

In some implementations, subject matter areas 404 and/or issues 346 are identified by a set of keywords. For example, a subject matter area may include a list of 20 keywords or word stems (e.g., dry and dryness have the same word stem), and when a paragraph or other portion of a posting has a certain number of the terms, it is assigned to the subject matter area. Other implementations utilize syntactic or semantic analysis of a sentence rather than just the presence of certain words (e.g., the word “dry” immediately preceding the word “skin,” or separated by a single word such as in “dry flaky skin,” but excluding the case where the words are not in the same sentence, such as “ . . . dry. My skin . . . ”).

FIG. 6 illustrates a process for providing recommendations 350 in accordance with some implementations. In this illustration the recommendations 350 are for products 336, but the same process applies to recommended actions as well (e.g., “apply moisturizer using circular motions” or “store the moisturizer in a cool dry location”). In this illustration, the recommendation module 332 indentifies a specific subject matter area 404 (subject matter area X), and identifies all of the postings 602 assigned to that subject matter area by subject matter experts. This includes postings 402-10, 402-11, 402-12, 402-13, . . . , 402-14, posted by respective subject matter experts 104-10, 104-11, 104-12, 104-13, . . . , 104-14. Some of these postings include recommendations for or against certain products, such as Product A and Product B. In general, the search is only for products 336 provided by the business entity, although some implementations track recommendations for the products of other companies as well, at least for analytic purposes. By limiting the postings 402 to those from identified subject matter experts, the noise of random recommendations is reduced.

Note that the recommendations can be either positive or negative. For example, a certain product may be positively recommended for some issues, but not recommended for other issues. In addition, some implementations take into account degrees of recommendation (e.g., strong recommendation, regular recommendation, neutral, regular recommendation against, strong recommendation against). Some implementations also include recommendations from postings of users 102/experts 104 on other social media 612. Whereas expertise within the online community 108 is more easily quantified and verified (e.g., identifying consistent relevant postings by the same user 102 over a period of time), it is more difficult to apply the same rules to other postings outside the community. In some implementations, a lower weight is given to the postings from external social media 116. In some implementations, recommendations from external social media 116 are included only when expertise in a subject matter are 404 has been determined in the same way as within the community (e.g., identify consistent relevant postings for the subject matter area over a period of time). In some implementations, there is a greater reliance on recommendations from external social media when there is a shortage of relevant postings within the community.

The recommendation module 332 within the analytic server 114 collects (604) the postings from the subject matter experts 104 for the subject matter area, extracts the product recommendations within the postings, aggregates the results, and stores (606) the recommendations 350 in the database 112. In this illustration the recommendations 350 are for products 336 (or services) offered by the business entity. In some implementations, the subject matter experts 104 are assigned weights based on various criteria, such as number of relevant postings to the subject matter area, length of time making postings to the subject matter area, the amount of recognition received from users. The weights are incorporated into the recommendation calculation.

The recommendation module typically operates as a batch process during off-peak usage of the online community 108, and the recommendations are stored (606). When a user 102 posts an issue or question 402, the natural language processing module analyzes the posting 402 to identify a subject matter area 404 (or multiple subject matter areas). When there are stored recommendations 350 for the subject matter area 404, the recommendations 350 can be provided (608) to the user 102 immediately. For example, in FIGS. 4 and 5, one expert recommended the brand “Sesquipedalian Beauty” for dry skin. If other experts also had the same recommendation, it could be a stored recommendation 350, and subsequently recommended to any user having a problem with dry skin. In some implementations, the recommendation module 332 can identify recommendations in real-time in response to a newly posed specific question (e.g., when there are no stored relevant recommendations, or to supplement the stored recommendations). That is, the process just described can occur in response to specific question posed by a user, generating one or more recommendations for the specific question posed.

In some implementations, multiple recommendations are presented to the user, which may include both previously stored recommendations as well as newly generated recommendations. In some implementations, the recommendations are ordered. The ordering can be based on the number of recommendations, the ranking of subject matter experts making the recommendations, the calculated relevance to the current user's posting, and so on. When ordered, the recommendations are presented to the user in that order.

In some implementations, the recommendation module 332 aggregates product recommendations for individual issues 346 rather than for subject matter areas. The process is similar to that described above, but the postings from experts that are included in the analysis are just those that have been designated as answers or solutions to the specific issue 346. Using issues rather than subject matter areas for product recommendations is particularly useful when the subject matter areas are defined broadly.

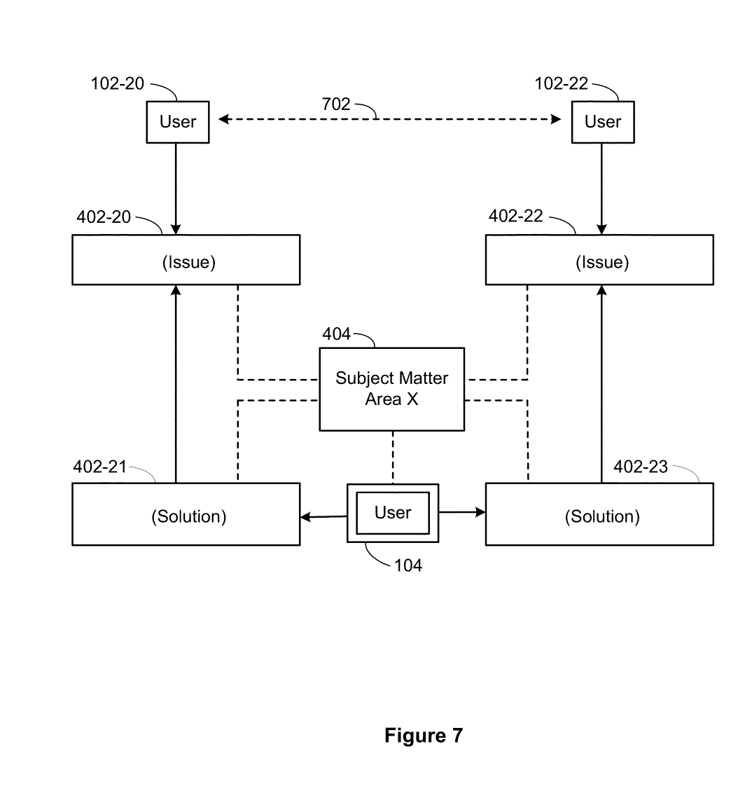

FIG. 7 illustrates a method of establishing a communication channel between two users 102 in an online social community 108 in accordance with some implementations. In this illustration, a first user 102-20 enters a posting 402-20 at the online community 108 that poses an issue or question. The posting 402-20 is assigned to a certain subject matter area 404 for which another user has been identified as a subject matter expert 104. The expert 104 posts a solution 402-21 in response to the posting 402-20 by the first user 102-20. The solution is also assigned to the subject matter area 404.

Later, a second user 102-22 enters a posting 402-22 at the online community 108, and it poses a question or issue as well. The two user postings 402-20 and 402-22 do not necessarily bring up the same exact issue, but they are both assigned to the same subject matter area 404. The same expert 104 posts a solution or answer 402-23 to the posting 402-22 of the second user. The analytic module 326 determines that the user postings 402-20 and 402-22 are both assigned to the same subject matter area, and both have received responses from the same subject matter expert 104. Because the issues raised by the first user 102-20 and second user 102-22 could be related, the analytic module sends a message to either the first user or the second user (or both), recommending that the users communicate (702) about the issue. Neither the first user 102-20 nor the second user 102-22 has been designated as a subject matter expert, but their issues may be sufficiently related that they can provide each other with information, support, connections to other useful resources, etc.

FIG. 8 illustrates some aspects of the natural language processing module 328 in accordance with some implementations. FIG. 8 includes the same two postings 402-1 and 402-2 shown earlier in FIGS. 4 and 5, with keywords 406-1 and 406-4 identified. The natural language processing module 328 applies (802) text analytics to each of the postings to extract pieces of information, categorize the information, and correlate that information with other extracted information. For example, each word is looked up in a dictionary, which identifies what part of speech the word could represent. In some instances, a word has a unique part of speech (e.g., “moisturizer” is a noun). However, in other instances, a word could have different usage depending on the context (e.g., “hammer” could be ether a noun or a verb). In other instances, even if the part of speech is known, there are multiple distinct meanings (e.g., the adjective “hot” could refer to temperature or could refer to an item being popular). Typically, ambiguity in word meanings can be resolved by the surrounding context. Some implementations also address misspellings, slang, abbreviations, acronyms, and other language constructs that people use, regardless of whether they are considered proper or grammatically correct (e.g., if a user enters the word “rosacia” in a posting, some implementations would interpret this as “rosacea”). In some implementations, context is also used to resolve the meaning of an acronym. For example, the acronym “PD” has many different meanings, including “Police Department” and “pupillary distance.” In the context of an optical business, the latter definition would probably be correct.

The annotation windows 850 and 852 illustrate how the extracted information is categorized and structured in accordance with some implementations. The annotation window 850 corresponds to the first issue in the posting 402-1. The first parameter here is “kind” 804, indicating that this parameter specifies what kind of data has been extracted. The value of this parameter is “condition” 812, indicating that the issue specifies a condition that a person or product may have. In this case, the condition has two object parameters “object1” 806 and “object2” 808, and the values of these parameters are the actual extracted values “patchy redness” 814 and “my face” 816. The fourth parameter “rule” 810 is used by the natural language processing module to specify a name for this condition.

The annotation window 852 corresponds to the posting 402-2. As with window 850, the first parameter “kind” 820 specifies a category for this posting. In this case, the value of the parameter is “advocate” 828, indicating that the posting advocates a certain product or action. In this example of advocacy, there is a product or action advocated as well as a specific reason or purpose. These correspond to the parameters “object” 822 and “reason” 824. The product advocated is “Sesquipedalian Beauty” 830, and the reason or purpose for the advocacy is “your skincare needs” 832. As in the window 850, there is a “rule” 826 assigned to this advocacy, which is the name “AdvocateRule1” 834. Some implementations generate names like “Condition1” 818 and “AdvocateRule1” 834 following a simple pattern (e.g., “Condition1” is the name for the first condition, “Condition2” is the name for the second condition, and so on).

The annotation windows 850 and 852 enable community administrators to review the processing of the natural language processing module 328, and to manually override the information when necessary. Therefore, the controls in these windows 850 and 852 enable an administrator to add, edit, or delete the data

Although the windows 850 and 852 illustrate two kinds of extracted data, implementations typically have 10-20 different categories. Some implementations include the categories “Address” and “Billing.”

FIG. 9 illustrates aspects of postings to an online social community and the time sequence of those postings in accordance with some implementations. As FIG. 9 illustrates, postings are created and added to the online community all the time. There is no fixed limit to the number of postings (although old postings that are less relevant may be archived if necessary to save space, reduce processing costs, or improve performance). In the illustration in FIG. 9, there are postings 402-30, 402-31, 402-32, . . . , 402-N at the time the snapshot was taken. Each posting has content 340, which is the text posted by the user. (Some implementations allow postings to include other content as well, such as attached or linked photos, audio files, or videos.) In addition to the content, each posting has corresponding primary metadata 342 and secondary metadata 344. In general, the primary metadata 342 is metadata that is known at the time the posting occurs, whereas the secondary metadata 344 is metadata that is associated with the content at some later time.

The primary metadata may include the author 902, what posting the content is responding to 904, the date/time 906 the posting occurred, and the posting type 908, which may be a question, an answer, a comment, a request for clarification, etc. Implementations have different sets of posting types. Some implementations include other metadata, when available, such as the device, operating system, and browser application that the user used to make the posting, the country or region where the posting originated, an IP address, and so on.

The secondary metadata is added as appropriate. For example, as soon as possible, the posting is assigned to one or more subject matter areas 910 (e.g., using natural language processing as described with respect to FIG. 8). In some cases, the posting receives feedback from others 912, which may be positive or negative. In some implementations, the feedback from others 912 is kept in a raw original format as well as an aggregated version. In some cases, the posting is designated as an accepted solution 914. In some cases the posting receives other awards 916, either from users 102 or from community administrators. The secondary metadata also includes the rules extracted by the natural language processing module 328. For example, the Condition) rule shown in annotation window 850 and the AdvocateRule1 rule shown in annotation window 852 may be stored in the secondary metadata 344 for the corresponding postings.

As noted previously, a single posting 402 is generally not enough to designate a person as a subject matter expert in a particular area 404, even if that one posting is very good. Instead, along the time line in FIG. 9, a single user would need several postings associated with the same subject matter area, each of which is deemed relevant and/or useful, in order for the user to be designated as a subject matter expert. Implementations use various techniques to determine whether a person has consistently provided useful postings for a subject matter area. In some implementations, the expert designation requires a certain number of relevant postings per week, month, or quarter for a certain period of time, such as six months or a year. Some implementations require at least one “recent” posting for a subject matter area in order to retain the expert designation (e.g., at least one posting in the past month, or past three months). In some implementations, the number of postings required to be designated as a subject matter expert depends on the quality or relevance of the postings. For example, three very good postings throughout a year might be equivalent to posting a dozen helpful but less valuable postings. Some implementations utilize both a relevance metric that is computed by natural language processing, as well as feedback from users, with appropriate weights assigned to each.

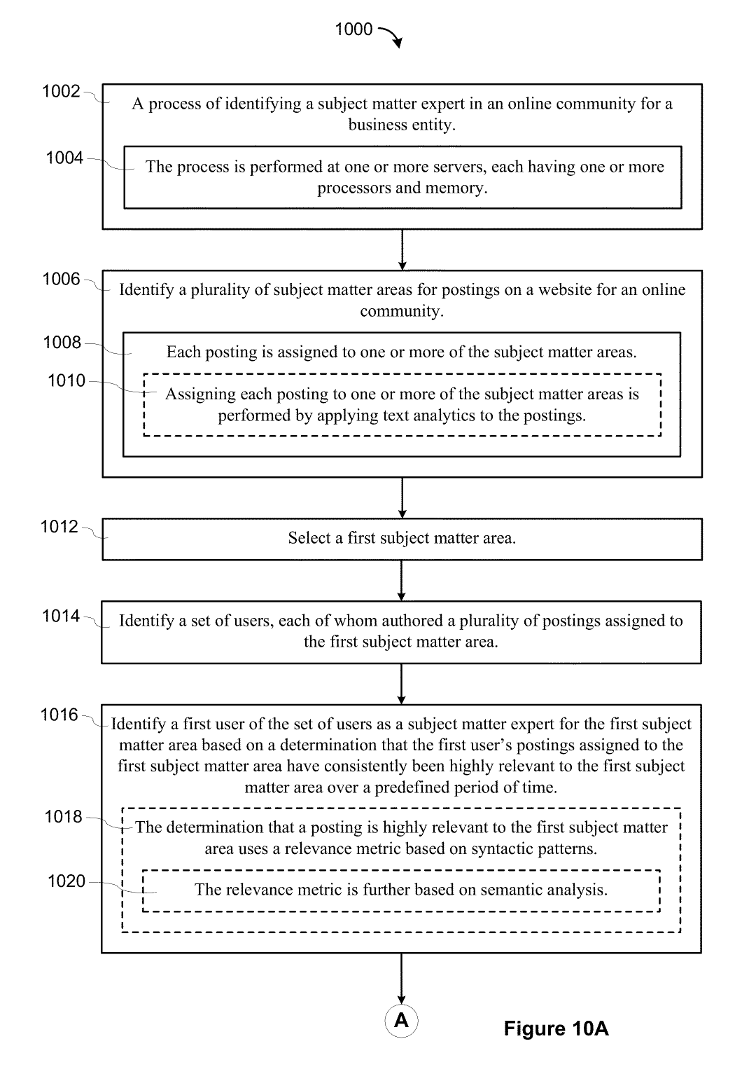

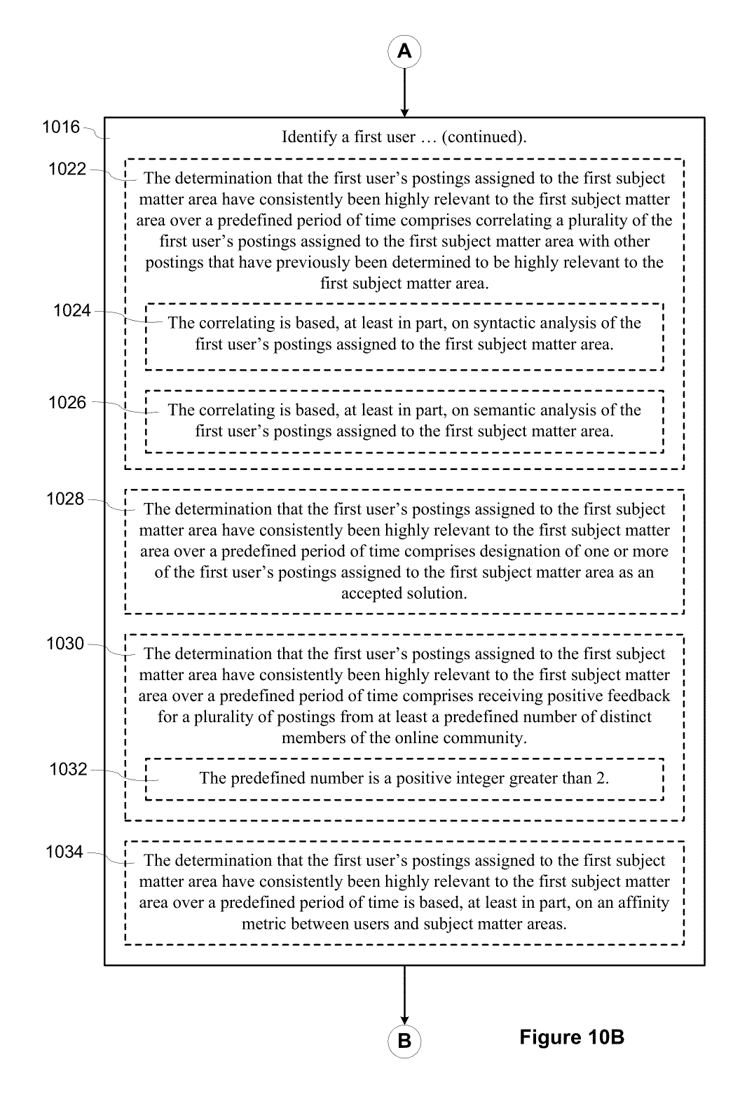

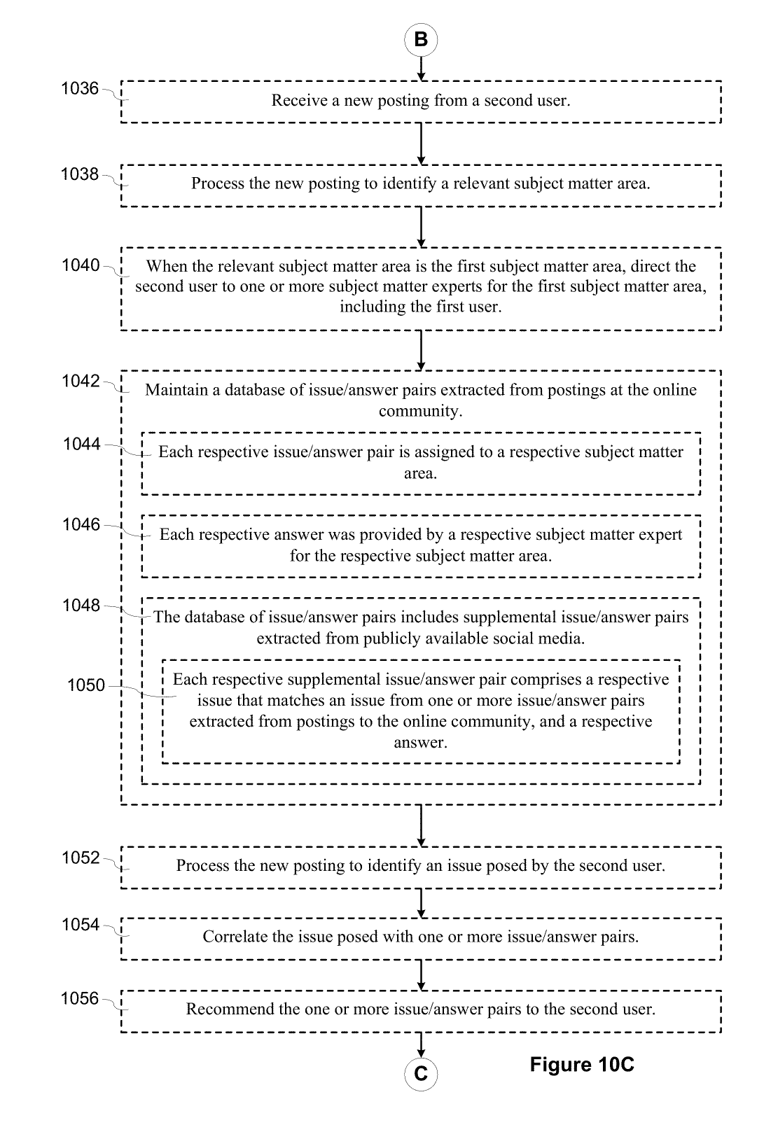

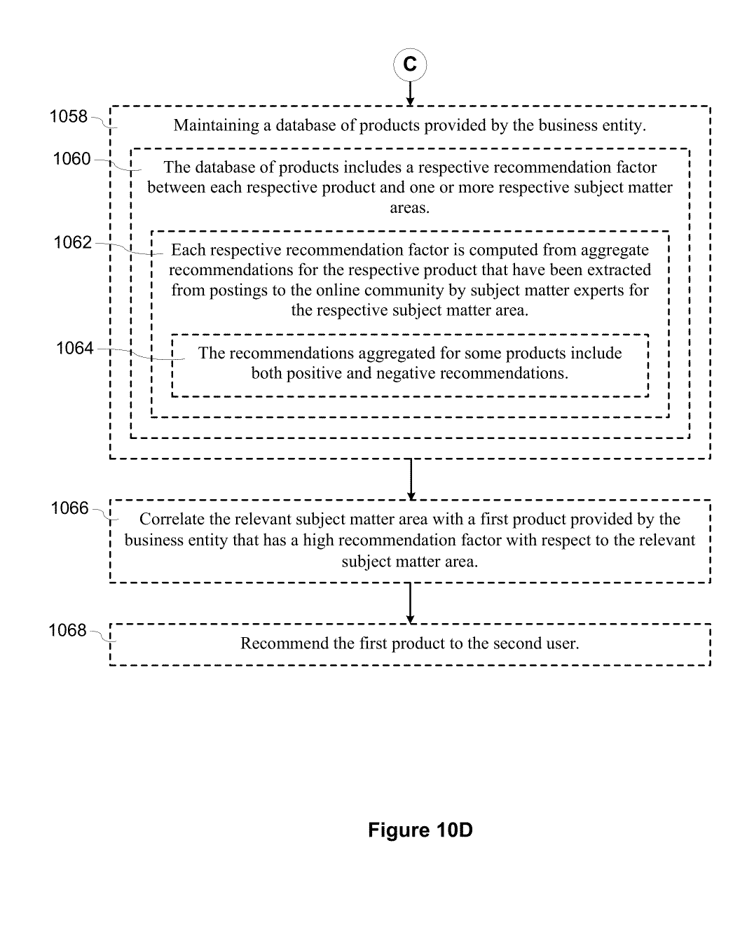

FIGS. 10A-10D provide a flowchart 1000 for a process 1002 of identifying subject matter expertise in an online social community 108 in accordance with some implementations. The process is performed (1004) at one or more servers, each having one or more processors and memory. The process 1002 identifies (1006) a plurality of subject matter areas 404 for postings 402 on the website for an online community 108. Different business entities can select the appropriate level of detail for subject matter areas. Typically, subject matter areas 404 are identified in a way so that a person identified as an expert for a certain subject matter area is an expert for at least the majority of that subject matter area 404. For example, a subject matter area 404 for “cosmetics” is likely to be too broad because a person with knowledge in some areas of cosmetics may not be an expert for all of cosmetics. On the other hand, a subject matter area for “dry skin” may be sufficiently narrow that a person could be an expert for that entire area.

Each posting 402 to the online community 108 is assigned (1008) to one or more subject matter areas 404. As illustrated in FIG. 4, a single posting 402 can be assigned multiple subject matter areas 404. Because subject matter areas are not required to be mutually exclusive, even a short simple posting may be assigned (1008) to multiple subject matter areas. In some implementations, assigning each posting to one or more of the subject matter areas 404 is performed (1010) by applying text analytics to the postings 402.

As used herein, the term “text analytics” is used essentially interchangeably with “natural language processing.” In some implementations, text analytics translates words and phrases from unstructured text into a standardized structured format using various techniques to identify patterns and annotate the words and phrases. This process categorizes the extracted data, and may utilize language syntax or semantics. Text analytics further analyzes the structured data to identify further patterns or relationships between elements of the structured data. In some implementations, the text analytic process forms entity relationship diagrams to model the structure of the text. In some implementations, the process is iterative. As illustrated in FIGS. 4 and 8, not all words and phrases are useful in the analysis of text, so an important part of text analytics is to identify the words or phrases that convey the overall meaning.

The process 1002 selects (1012) a first subject matter area 404, and identifies (1014) a set of one or more users 102, each of whom authored a plurality of postings 402 assigned to the first subject matter area 404. The process 1002 then identifies (1016) a first user 102 of the set of one or more users as a subject matter expert 104 for the first subject matter area 404 based on a determination that the first user's postings 402 assigned to the first subject matter area 404 have consistently been highly relevant to the first subject matter area 404 over a predefined period of time (e.g., 6 months, a year, or two years).

Designation as a subject matter expert 104 should be limited to individuals who really are experts in a certain area. Just entering many postings 102 at the online community 108 is not enough. In particular, if the postings 402 from one user 102 are on many different unrelated topics, the user 102 may not have demonstrated expertise in any particular area. Furthermore, even if there are multiple postings 402 in the same subject matter area 404, the user 102 is not an expert unless the postings 402 are identified as useful and relevant. In addition, isolated high quality postings in a subject matter area 404 are insufficient to establish general expertise (e.g., one brilliant posting is not enough). Therefore, designation as a subject matter expert requires consistent highly relevant postings over a period of time.

In some implementations, the determination that a posting is highly relevant to the first subject matter area 404 uses (1018) a relevance metric based on syntactic patterns. For example, in the response 402-2 illustrated in FIG. 4, the phrase “I would suggest” is a language pattern that indicates the user 102 is recommending a solution. As this same example shows, some implementations also utilize (1020) semantic analysis for the relevance metric (e.g., the word “suggest” means the user is providing a recommendation). Similarly, the later words “drier skin” in the posting 402-2 indicates that the response addresses the dry skin issue in the original user's posting 402-1. The syntax of the reply 402-2 indicates the user 102 is providing a recommendation, and this is confirmed by the identification of “the brand ‘Sesquipedalian Beauty.’” In this instance, the recommendation is not a single specific product 336, but a brand line. However, the phrase “Sesquipedalian Beauty” can be correlated to the products 336 based on the brand name. In this instance, the user 102 specifically identifies “Sesquipedalian Beauty” as a “brand,” but even without that indicator, the natural language processing module 328 would correlate the brand name to the products.

Various additional techniques are used to determine that the first user's postings assigned to the first subject matter area have consistently been highly relevant to the first subject matter area over a predefined period of time. In some implementations, this determination is based, at least in part, on correlating (1022) a plurality of the first user's postings assigned to the first subject matter area 404 with other postings 402 that have previously been determined to be highly relevant to the first subject matter area 404. In some implementations, the correlating is based, at least in part, on syntactic analysis (1024) of the first user's postings 402 assigned to the first subject matter area 404. For example, the first user's posting may have a similar syntactic structure as other highly relevant postings 402.

In some implementations, the correlating is based, at least in part, on semantic analysis (1026) of the first user's postings 402 assigned to the first subject matter area 404. For example, if a posting 402 by a first user includes words that are the same (or synonyms or having the same word stem) as postings that are already identified as highly relevant to the subject matter area 404, then the posting 402 may be highly relevant as well. In some implementations, syntactic analysis is applied in addition to semantic analysis. For example, looking at not just the presence of certain words in a posting 402, but also the logical organization of those words.

In some implementations, the determination that the first user's postings assigned to the first subject matter area have consistently been highly relevant to the first subject matter area over a predefined period of time comprises (1028) designation of one or more of the first user's postings 102 assigned to the first subject matter area as an accepted solution. Designation of a posting as an accepted solution entails a consensus opinion by multiple users that the identified solution is useful, and typically indicates that it is a better solution than the ones presented by other users. For this reason, postings 402 that are accepted solutions for a certain subject matter area 404 are a good indicator that the author is a subject matter expert 104 for that area 404.

Even if a posting 402 is not designated as an accepted solution, significant positive feedback from other users is a good indicator of subject matter expertise. Therefore, in some implementations, the determination that the first user's postings 402 assigned to the first subject matter area 404 have consistently been highly relevant to the first subject matter area 404 over a predefined period of time comprises (1030) receiving positive feedback for a plurality of postings 402 from at least a predefined number of distinct members of the online community. In some implementations, the predefined number is (1032) a positive integer greater than 2. In some implementations, positive feedback from others is measured on a sliding scale, and the strength of that feedback is included in an overall evaluation of subject matter expertise. In this case, the strength of the positive feedback depends on the quantity of the feedback, any offsetting negative feedback, the consistency of the feedback over time, the number of distinct postings by the first user 102 that receive positive feedback, and so on.

Some implementations compute an affinity metric between users and subject matter areas, and include this in the analysis of subject matter expertise. In particular, in some implementations, the determination that the first user's postings 402 assigned to the first subject matter area 404 have consistently been highly relevant to the first subject matter area 404 over a predefined period of time is based (1034), at least in part, on an affinity metric between users and subject matter areas. That is, rather than evaluating a single user 102 and a single subject matter area 404, some implementations compute an affinity metric between a broad group of users and the set of subject matter areas. This analysis sometimes reveals that a certain user 102 has a greater affinity to a certain subject matter area than other users, and thus should be designated as a subject matter expert 104, even if the other evaluation techniques do not provide such as correlation (e.g., insufficient positive feedback from other users). An affinity metric can also reveal that a certain user is more closely associated with certain subject matter areas 404 than other subject matter areas. Because an affinity metric measures the correlation between many users and many subject matter areas simultaneously, it can provide information not available by other techniques. In some implementations, the information provided by an affinity metric is combined with the information from other techniques to identify subject matter experts.

In some implementations, the process 1002 receives (1036) a new posting 402 from a second user 102, and analyzes (1038) the new posting 402 to identify a relevant subject matter area. When the relevant subject matter area is the first subject matter area 404, the second user 102 is directed (1040) to one or more subject matter experts for the first subject matter area 404, including the first user. In this way, the second user 102 is quickly directed to an expert for the specific issue posed, instead of forcing the user to search through hundreds or thousands of generally non-relevant postings.

In some implementations, the listing of subject matter experts is ranked or filtered. In some implementations, the subject matter experts are ranked based on their contributions to the subject matter area, which may involve number of postings, the quality of those postings, the length of time making postings relevant to the subject matter area, feedback from other users, and so on. In some implementations, the ranking is based on the correlation of postings by the subject matter experts to the new posting 402 from the second user. For example, when subject matter areas are defined more broadly, certain subject matter experts may be more relevant than others to the content of the new posting 402. In some implementations, the ranking of the experts is based on both the objective ranking of the experts themselves as well as the relevance to the new posting. In some implementations, the list of subject matter experts is also filtered. In some implementations, the filtering just limits the number of subject matter experts on the list (e.g., top 3 or top 5). In some implementations, other criteria may be used for filtering, such as geographic location of the second user in relation to the geographic location of the experts (e.g., when local expertise is needed or useful).

In addition to directing the second user 102 to appropriate subject matter experts 104, some implementations also direct the second user to specific postings by those experts for the first subject matter area. This is particularly valuable when the subject matter areas are defined narrowly. Based on the fact that the new posting 402 corresponds to a certain subject matter area, and another person has been identified as a subject matter expert 104 for that subject matter area 404, it is likely that other postings by that subject matter expert may be helpful to the second user. In this way, the second user is directly linked to postings that might be useful rather than putting the burden on the second user to find the relevant postings.

In some implementations, the list of postings authored by the subject matter experts for the first subject matter area 404 are sorted or filtered. The process of sorting or filtering postings can be based on various factors that are independent of the new posting, including the ranking of the corresponding author, the specific feedback from others regarding each posting, and the recency of the postings. Some implementations also sort or filter the postings based on the relevance of each posting to the new posting. In some implementations, the number of postings presented is limited to a certain number, such as 5 or 10. In some implementations, when the number is limited, the user interface provides an option to view additional postings (e.g., using a “MORE” button).

Directing the second user to a list of subject matter experts and directing the second user to a list of postings authored by those subject matter experts may occur together, or individually. Some implementations use only one or the other, or present only one at a time.

In some implementations, the online community 108 maintains (1042) a database of issue/answer pairs 348 extracted from postings 402 at the online community 108. Each respective issue/answer pair 348 is assigned to (1044) a respective subject matter area 404. Each respective answer was provided (1046) by a respective subject matter expert 104 for the respective subject matter area 404. In some implementations, the database of issue/answer pairs includes (1048) supplemental issue/answer pairs 348 extracted from publicly available social media 116. Each respective supplemental issue/answer pair 348 comprises (1050) a respective issue 346 that matches an issue from one or more issue/answer pairs 348 extracted from postings 402 to the online community 108, and a respective answer extracted from the social media.

The database of issue/answer pairs 348 can be used to provide users 102 with quick responses to their issues when an issue posed matches an issue that has been previously addressed. In some instances, a new posting 402 from a second user 102 is received (1036), and the new posting 402 is analyzed (1052) to identify an issue 346 posed by the second user 102. The issue 346 posed by the second user is correlated (1054) with one or more of the issue/answer pairs 348 stored in the database 112, and those one or more issue/answer pairs 348 are recommended (1056) to the second user.

In some implementations, the online community 108 maintains (1058) a database of products 336 provided by the business entity. When appropriate, it is useful to recommend these products to users 102 of the community 108. The database of products 336 includes (1060) a respective recommendation factor between each respective product 336 and one or more respective subject matter areas 404. (In some implementations, the correlation factor is between products 336 and issues 346.) Each respective recommendation factor is computed (1062) from aggregate recommendations for the respective product 336 that have been extracted from postings 402 to the online community 108 by subject matter experts 104 for the respective subject matter area 404. This process was described above with respect to FIG. 6. In some implementations, the recommendations aggregated for some products include (1064) both positive and negative recommendations. Because the recommendations are from users 102 who have been designated as subject matter experts 104, and the process of designation as a subject matter expert requires substantial relevant postings over a period of time, the recommendations are less affected by random or irrelevant user opinions.

The database of recommendations 350 can be used to provide users with product recommendations specifically suited to the issues they are having. In some implementations, a new posting 402 is received (1036) from a second user 102, and the new posting 402 is analyzed (1038) to identify a relevant subject matter area 404. The relevant subject matter area 404 is then correlated (1066) with a first product 336 provided by the business entity that has a high recommendation factor with respect to the relevant subject matter area 404. (In some implementations, an issue 346 is identified for the new posting 402, and the issue 346 is correlated with a first product 336.) The first product 336 is recommended (1068) to the second user 102. Although described here with respect to recommending a product 336, some implementations apply the same process to recommending a service or recommending an action. For example, in the context of a business providing network routers, the recommendation could be to download and install the latest firmware version for the router.

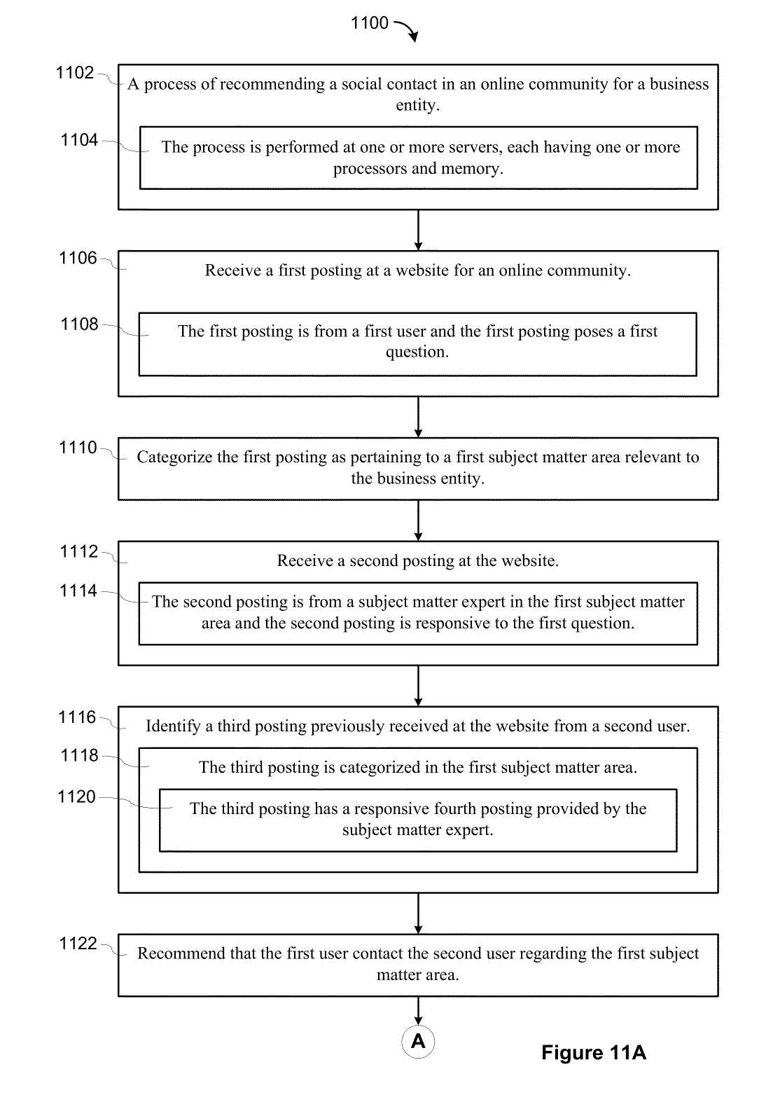

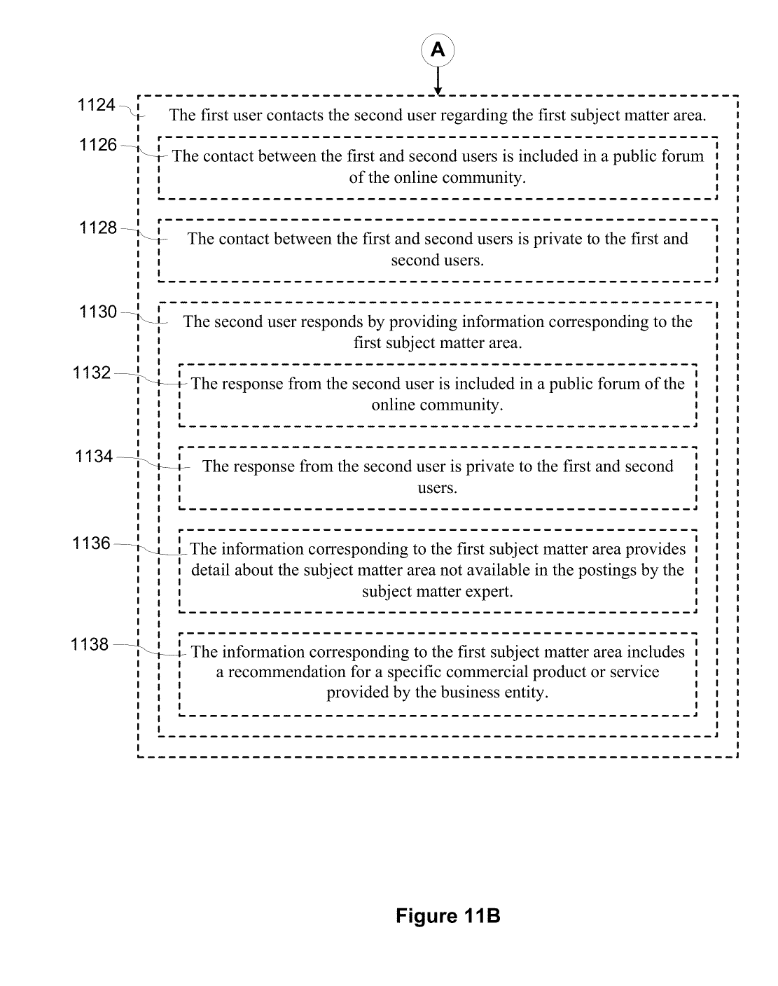

FIGS. 11A-11B provide a flowchart 1100 for a process 1102 of utilizing subject matter experts 104 to recommend connections between members of an online social community 108 in accordance with some implementations. The process is performed (1104) at one or more servers, each having one or more processors and memory

The process 1102 receives (1106) a first posting 402 at a website for an online community 108. The first posting 402 is (1108) from a first user 102 and the first posting 402 poses (1108) a first question. The process 1102 categorizes (1110) the first posting 402 as pertaining to a first subject matter area 404 relevant to the business entity. The process 1102 later receives (1112) a second posting 402 at the website. The second posting 402 is (1114) from a subject matter expert 104 for the first subject matter area 404 and the second posting 404 is (1114) responsive to the first question.

The process 1102 identifies (1116) a third posting 402 previously received at the website from a second user 102. In some instances, the third posting poses an issue 346 or question. The third posting is categorized (1118) in the first subject matter area 404. In addition, the third posting 402 has (1120) a responsive fourth posting 402 provided by the subject matter expert 104.

Each of the first and second users has a posting (one or more) to the online community, those postings are categorized in the same subject matter area 404, and both have responses from the same subject matter expert 104. There is a reasonable chance that the first and second users have related issues. In an ordinary online community, there is a chance that the first and second users might discover each other after searching through online postings 402. Some implementations of the present invention, however, utilize the two users' connections to a subject matter expert in a specific area to identify the possible connection to each other. In this way, the process 1102 recommends (1122) that the first user contact the second user (or vice versa, or both) regarding the first subject matter area.

In some implementations where the subject matter areas 404 are configured broadly, the same technique is applied to issues 346 instead (or in addition). In this case, the issues 346 posed by the first and second users sufficiently coincide, and both have responses from a subject matter expert 104 who has provided responses to those issues. In the same way, the process 1102 recommends (1122) that the first and second users contact each other.

In some instances, the first user 102 contacts (1124) the second user 102 regarding the first subject matter area. Depending on the implementation or configuration, the contact between the first and second users is either included (1126) in a public forum of the online community or is (1128) private to the first and second users. In some instances, the second user responds (1130) by providing information corresponding to the first subject matter area. Like the original contact, the response can either be included (1132) in a public forum of the online community or be (1134) private to the first and second users.

Although the second user is not designated as a subject matter expert, the second user may be able to provide useful information based on first hand experience. In fact, in some instances it is useful just to know that someone else is experiencing the same problem. In some instances, the information corresponding to the first subject matter area provides (1136) detail about the subject matter area not available in the postings by the subject matter expert. In some instances, the information corresponding to the first subject matter area includes (1138) a recommendation for a specific commercial product or service provided by the business entity. Note that this is different from the recommendations 350 provided by subject matter experts 104. In some circumstances, a recommendation from a second user 102 who is experiencing (or has experienced) the same problem may be more useful to and/or carry more weight for the first user who is deciding what to do.

One of skill in the art recognizes that the illustration of connecting two users based on their shared connection to a subject matter expert 104 can be extended to form a community interaction graph that includes various connections between users 102, experts 104, products 336, issues 348, subject matter areas 404, and so on. This graph can capture the issues people are trying to solve, the solutions that are being recommended, who are the people reporting the problems, who are the people recommending solutions, what products are recommended, what products people are told to avoid, and so on. Like affinity metrics, analysis of a community interaction graph can identify information that may not be apparent when viewing only a small portion of the data.

The foregoing description, for purpose of explanation, has been described with reference to specific implementations. However, the illustrative discussions above are not intended to be exhaustive or to limit the invention to the precise forms disclosed. Many modifications and variations are possible in view of the above teachings. The implementations were chosen and described in order to best explain the principles of the invention and its practical applications, to thereby enable others skilled in the art to best utilize the invention and various implementations with various modifications as are suited to the particular use contemplated.

What is claimed is:

1. A method of recommending a social contact in an online community for a business entity, performed at a server having one or more processors and memory, the method comprising:
receiving a first posting at a website for an online community, wherein the first posting is from a first user and the first posting poses a first question;
categorizing the first posting as pertaining to a first subject matter area relevant to the business entity;
receiving a second posting at the website, wherein the second posting is from a subject matter expert in the first subject matter area and the second posting is responsive to the first question;
identifying a third posting previously received at the website from a second user, wherein the third posting is categorized in the first subject matter area and has a responsive fourth posting provided by the subject matter expert; and
recommending that the first user contact the second user regarding the first subject matter area.

2. The method of claim 1, wherein the first user contacts the second user regarding the first subject matter area, and the second user responds by providing information corresponding to the first subject matter area.

3. The method of claim 2, wherein the information corresponding to the first subject matter area provides detail about the subject matter area not available in the postings by the subject matter expert.

4. The method of claim 2, wherein the information corresponding to the first subject matter area includes a recommendation for a specific commercial product or service provided by the business entity.

5. The method of claim 2, wherein the contact and response between the first and second users are included in a public forum of the online community.

6. The method of claim 2, wherein the contact and response between the first and second users are private to the first and second users.

7. A computer server system providing an online community for customers of a business entity, comprising:
one or more processors;
memory; and
one or more programs stored in the memory, the one or more programs including instructions for:
receiving a first posting at a website for an online community, wherein the first posting is from a first user and the first posting poses a first question;
categorizing the first posting as pertaining to a first subject matter area relevant to the business entity;
receiving a second posting at the website, wherein the second posting is from a subject matter expert in the first subject matter area and the second posting is responsive to the first question;
identifying a third posting previously received at the website from a second user, wherein the third posting is categorized in the first subject matter area and has a responsive fourth posting provided by the subject matter expert; and
recommending that the first user contact the second user regarding the first subject matter area.

8. The computer server system of claim 7, wherein the one or more programs further comprise instructions for the first user to contact the second user regarding the first subject matter area, and instructions for the second user to respond, thereby providing the first user with information corresponding to the first subject matter area.

9. The computer server system of claim 8, wherein the information corresponding to the first subject matter area provides detail about the subject matter area not available in the postings by the subject matter expert.

10. The computer server system of claim 8, wherein the information corresponding to the first subject matter area includes a recommendation for a specific commercial product or service provided by the business entity.

11. The computer server system of claim 8, wherein the instructions for the first user to contact the second user and the instructions for the second user to respond are configured for execution as part of a public forum of the online community.

12. The computer server system of claim 8, wherein the instructions for the first user to contact the second user and the instructions for the second user to respond are configured for execution as a private communication between the first and second users.

13. A computer readable storage medium storing one or more programs configured for execution by a computer server system, the one or more programs comprising instructions for:
receiving a first posting at a website for an online community, wherein the first posting is from a first user and the first posting poses a first question;
categorizing the first posting as pertaining to a first subject matter area relevant to the business entity;
receiving a second posting at the website, wherein the second posting is from a subject matter expert in the first subject matter area and the second posting is responsive to the first question;
identifying a third posting previously received at the website from a second user, wherein the third posting is categorized in the first subject matter area and has a responsive fourth posting provided by the subject matter expert; and
recommending that the first user contact the second user regarding the first subject matter area.

14. The computer readable storage medium of claim 13, wherein the one or more programs comprise instructions for the first user to contact the second user regarding the first subject matter area, and instructions for the second user to respond, thereby providing the first user with information corresponding to the first subject matter area.

15. The computer readable storage medium of claim 14, wherein the information corresponding to the first subject matter area provides detail about the subject matter area not available in the postings by the subject matter expert.

16. The computer readable storage medium of claim 14, wherein the information corresponding to the first subject matter area includes a recommendation for a specific commercial product or service provided by the business entity.

17. The computer readable storage medium of claim 14, wherein the instructions for the first user to contact the second user and the instructions for the second user to respond are configured for execution as part of a public forum of the online community.

18. The computer readable storage medium of claim 14, wherein the instructions for the first user to contact the second user and the instructions for the second user to respond are configured for execution as a private communication between the first and second users.
